(19) United States
(12) Patent Application Publication
(10) Pub. No.: US 2008/0294606 A1
(43) Pub. Date: Nov. 27, 2008

(54) Aggregating Web Datastore Server for Drilling Information

(75) Inventors: David P. Moran, Woodlands, TX (US); Yashodhan Gidh, Sugar Land, TX (US); Lei Yan, Houston, TX (US)

Correspondence Address: OSHA, LIANG LLP / SMITH, 1221 MCKINNEY STREET, SUITE 2800, HOUSTON, TX, 77010, US

(73) Assignee: SMITH INTERNATIONAL, INC., Houston, TX (US)

(21) Appl. No.: 12/095,338

(22) PCT Filed: Feb. 6, 2007
(86) PCT No.: PCT/US07/03041

§ 371 Date: May 29, 2008

Related U.S. Application Data
(60) Provisional application No. 60/765,694, filed on Feb. 6, 2006.

(51) Int. Cl. G06F 7/06; G06F 7/00; G06F 17/30

(52) U.S. Cl. 707/3; 707/103 R; 707/E17.014; 707/E17.055

(57) ABSTRACT

A method for aggregating data that includes obtaining a log object including a log element, wherein the log element includes oilfield data obtained from a provider, obtaining an aggregation policy for the log element, and aggregating the log element into an aggregated object based on the aggregation policy is disclosed.

### CROSS-REFERENCE TO RELATED APPLICATIONS

This application contains subject matter related to U.S. patent application entitled “Method of Real-Time Drilling Simulation” (attorney docket no. 05516.256001), which is incorporated by reference in its entirety.

### BACKGROUND

In the oil and gas and geothermal drilling industry, a number of proprietary systems for measurement, transfer, storage, and recall of measured data values are commercially available. Typically, each of these proprietary systems stores measured data in a proprietary format and only allows access to the stored measured data via a proprietary interface. Further, once the stored measured data has been accessed, it is typically displayed in a manner that is unique to the proprietary system.

Some industry standards have been developed for allowing data gathered/stored by one proprietary system at to be accessed by another proprietary system. One such standard is the Wellsite Information Transfer Standard (WITS). The WITS standard requires the provider and the receiver of the data to communicate and agree oil the shape, content, and media of the transfer file. This standard is designed for data communications such as a serial connection between two computers to transfer data. In the WITS format, data files are typically in American Standard Code for Information Interchange (ASCII) format. Per WITS, the data is organized using tab delimited columns and row delimited steps to denote depth or time increments.

A revision of the WITS standard, known as the Wellsite Information Transfer Standard Markup Language (WITSML), has been developed to allow the transfer of drilling information across the World Wide Web (WWW). WITSML leverages eXtensible Mark-up Language (XML) to store the measured data.

### SUMMARY

In one aspect, the present invention relates to a method for aggregating data that includes obtaining a log object comprising a log element, wherein the log element comprises oilfield data obtained from a provider, obtaining an aggregation policy for the log element, and aggregating the log element into an aggregated object based on the aggregation policy.

In another aspect, the present invention relates to an aggregating datastore server, comprising a log object application programming interface (API) configured to obtain a log object comprising a log element, wherein the log element comprises oilfield data obtained from a provider, an aggregation policy API configured to obtain an aggregation policy for the log element, and an aggregation logic unit configured to aggregate the log element into an aggregated object based on the aggregation policy.

In another aspect, the present invention relates to a computer readable medium comprising software instructions for aggregating data in an aggregating datastore server, the software instructions executable on the aggregating datastore server to obtain a log object comprising a log element, wherein the log element comprises oilfield data obtained from a data provider, obtain an aggregation policy, and aggregate the log element into an aggregated object based on the aggregation policy.

Other aspects and advantages of the invention will be apparent from the following description and the appended claims.

### BRIEF DESCRIPTION OF DRAWINGS

FIG. 1 shows a drilling system in accordance with an embodiment of the invention.

FIG. 2A shows a log element in accordance with an embodiment of the invention.

FIG. 2B shows an aggregated element in accordance with an embodiment of the invention.

FIG. 2C shows an aggregation policy in accordance with an embodiment of the invention.

FIG. 3 shows an aggregation layer in accordance with an embodiment of the invention.

FIG. 4 shows an aggregation layer in accordance with an embodiment of the invention.

FIG. 5 shows a method for aggregating a data value in accordance with an embodiment of the invention.

FIG. 6 shows a method for providing a requested value to a client in accordance with an embodiment of the invention.

FIG. 7 shows an example of a datastore in accordance with an embodiment of the invention.

FIG. 8 shows a computer system in accordance with an embodiment of the invention.

FIG. 9 is a schematic representation of communication connections relating to a drilling process in accordance with embodiments of the present invention.

FIG. 10 is a schematic view drawing of a rig network in accordance with embodiments of the present invention.

### DETAILED DESCRIPTION

Exemplary embodiments of the invention will be described with reference to the accompanying figures. Like items in the figures are shown with the same reference numbers. Further, the use of “ST” in the figures is equivalent to the use of “Step” in the detailed description below.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and apparatus for obtaining oilfield data. More specifically, one or more embodiments of the invention relate to a method and apparatus for aggregating oilfield information from multiple data providers. By “oilfield data” the present application means any data that may be used by those in the hydrocarbon industry (i.e., in the planning, drilling, production, and/or remediation of oil and/or natural gas).

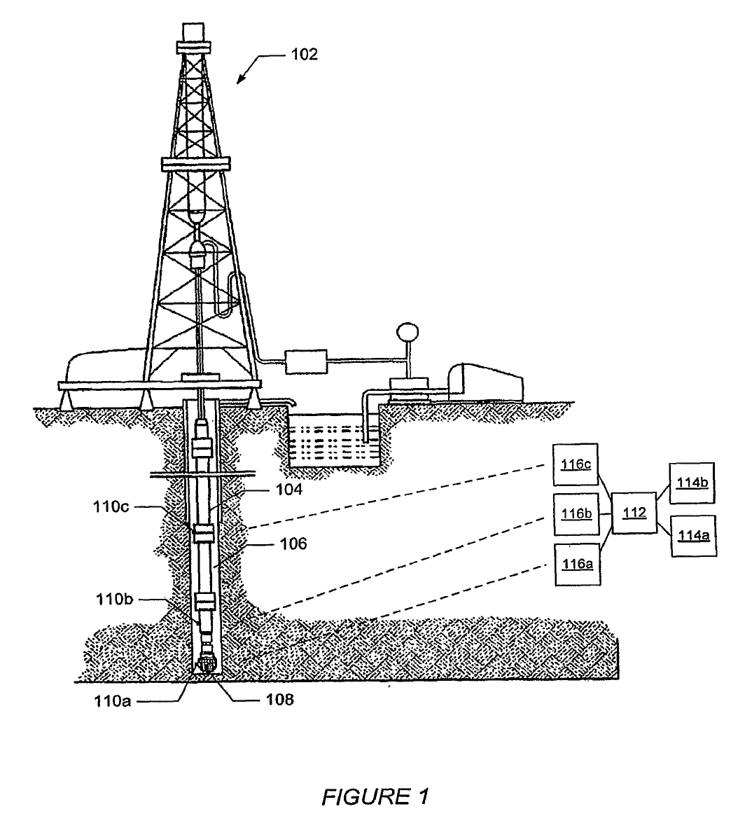

FIG. 1 shows a drilling system in accordance with an embodiment of the invention. The drilling system includes a drilling rig (102) used to turn a drill string (104), which extends downward into a well bore (106). Connected to the end of the drill string (104) is a roller cone-type drill bit (108) (not limited to roller cone-type). One skilled in the art will appreciate that numerous configurations exist for a drilling rig, and the particular configuration discussed is not intended to limit the scope of the invention.

Provided at varying positions in the well bore (106) are sensors (110a, 110b, 110c) used to obtain well bore data. These sensors transmit measured data, each instance of which is known as a log object (not shown), via known mechanisms (e.g., wireline transmission, wireless transmission during measurements-while drilling (MWD) operations, etc.) to one or more computer systems (116a, 116b, 116c), which manage the received data. The computer systems (116a, 116b, 116c), known as providers, provide data obtained from the sensors to an aggregation server (112). The providers (116a, 116b, 116c) may perform operations on the data such as, for example, normalizing the data from the sensors (110a, 110b, 110c), or converting the data in the log object from a proprietary format to a common format.

The aggregation server (112) is connected to one or more sensors (110a, 110b, 110c) and/or one or more providers (116a, 116b, 116c) via a number of mechanisms known in the art. Similarly, the aggregation server (112) may be connected to one or more clients (e.g., 114a, 114b) via a number of mechanisms known in the art (e.g., the Internet). While each sensor (110a, 110b, 110c) transmits measured data to a corresponding provider (116a, 116b, 116c) in FIG. 1, a sensor may transmit measured data to multiple providers, directly to the aggregation server (112), or to multiple aggregation servers in other embodiments of the invention. Further, a provider (e.g., 116a) may receive measured data from multiple sensors. Similarly, an aggregation server (e.g., 112) may receive measured data from multiple providers, or from multiple sensors, or a combination of providers and sensors.

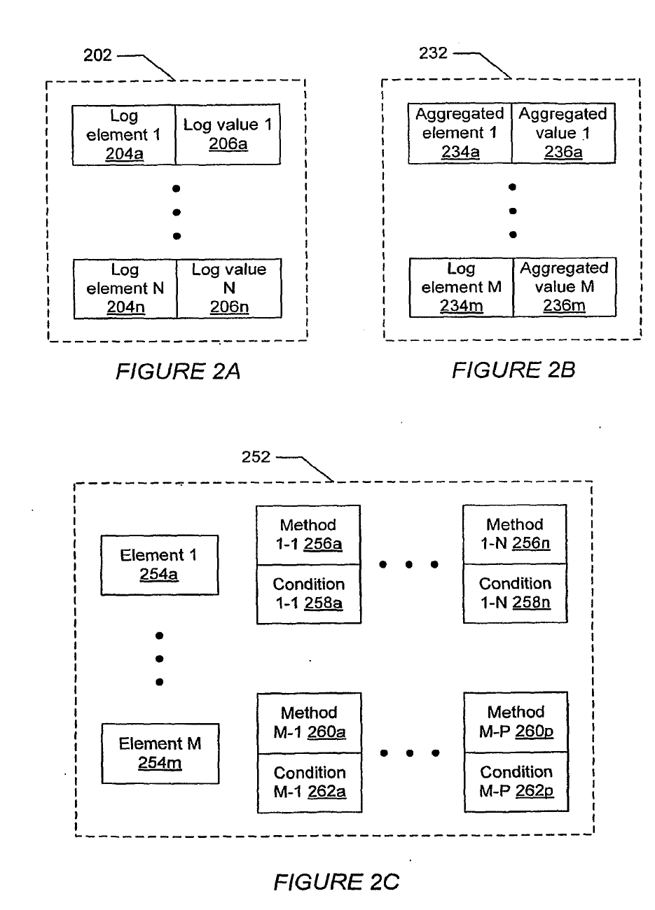

FIG. 2A shows a log object (202) in accordance with an embodiment of the invention. The log object (202) contains measured data that has been obtained by a sensor (e.g., sensor 110a). Each log element (e.g., 204a) represents a value measured by a sensor in a wellbore (e.g., wellbore 106). The log object (202) includes one or more log elements (204a, . . . , 204n), with each log element corresponding to a log value (206a, . . . , 206n) (i.e., the value measured by the sensor). In other words, the log element (204a) is a parameter indicating a type of measurement that corresponds to a log value (e.g., 206a), which is the measured value. In other embodiments of the invention, log elements may be coded such that they contain information corresponding to a measurement and a measured value. Thus, a single log element may be used instead of a log element/value pair in one or more embodiments of the invention. Data in a log object may be stored in a proprietary format, or in a common format.

Returning to FIG. 1, a typical well drilling project includes an operating company and a number of service providers (“providers”) contracted by the operating company. Each sensor (e.g., 110a) in a well bore (106) may be provided by one or more of these various providers necessary to drill and complete the well bore (106). Thus, each provider (116) provides one or more log objects, on behalf of a given log element, to the aggregation server (112).

Providers may include, but are not limited to, any one of the following: a drilling contractor (providing a drilling rig and related tubular equipment (drill pipe, etc.)); rig instrumentation (responsible for process measurements related to well drilling and construction); a drilling fluids contractor (responsible for drilling fluid used in drilling and completions phases of a project); a directional drilling service (specialty personnel for drilling directional well paths); a logging while drilling (LWD) or measurement while drilling (MWD) provider (a provider of tools used down hole to measure aspects of a well path); a mud logging service (geological and engineering data recording, analysis and presentation); pore pressure detection (a specialty service for maintaining safety in over-pressured drilling environments); a safety monitoring service (where poisonous gas is a possibility); a casing service (a specialty service for running casings into the well bore); a cementing service (a specialty service for cementing steel casing in place in a well bore); a communications or satellite provider (a communications service for data and telephony from a rig site location); an equipment supplier (fuel, drilling water, potable water, food and housing services, and consumable items such as drill bits, casing, materials, etc.); and transportation such as trucking, cranes, aircraft, support vessels for offshore wells).

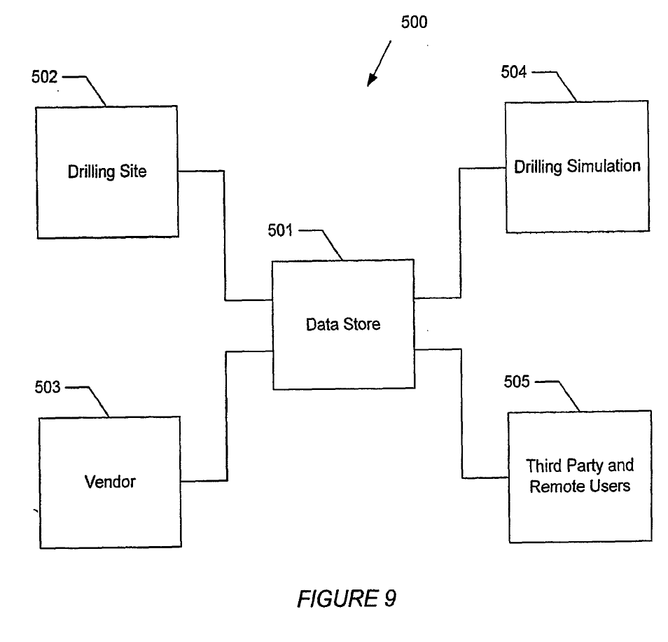

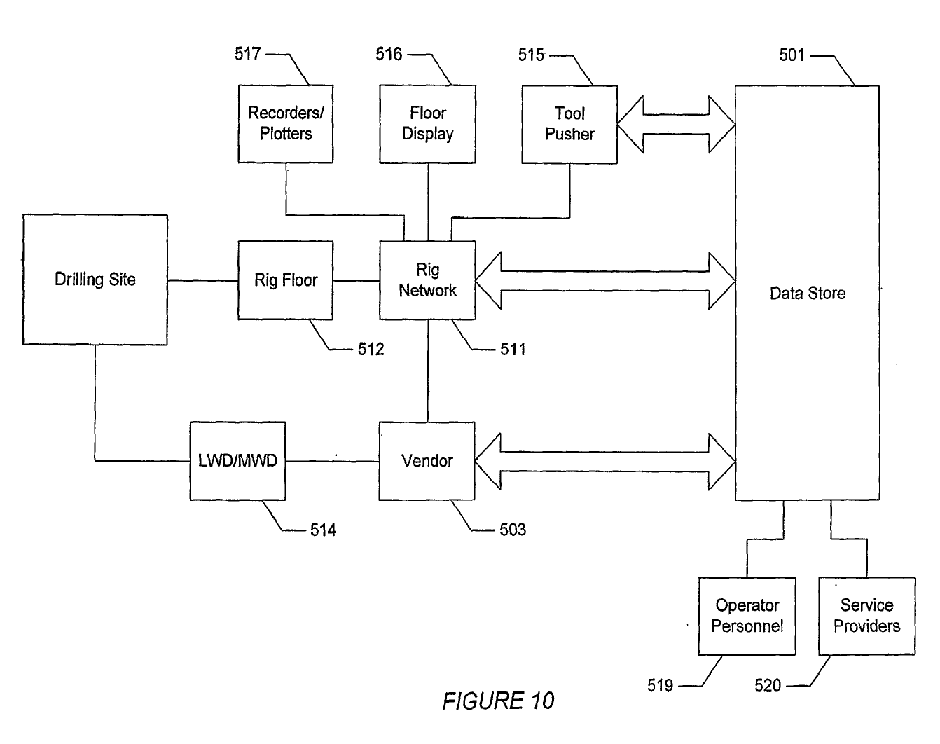

One exemplary embodiment describing how this data may be acquired by one provider is found below, with reference to FIGS. 9 and 10. Those having ordinary skill in the art will appreciate the types and nature of the data that each of the non-comprehensive list of providers may have.

Each of the aforementioned providers may provide one or more log objects to the aggregation server (112). In general, log objects correspond to any data measured by (via a sensor) or input by a provider. Examples of measured values in a log object include, but are not limited to: time, depth, rate of penetration (ROP), pressure, temperature, and rotational speed of the drill bit in revolutions per minute (RPM).

In one embodiment of the invention, a given measurement type may be provided by multiple sensors (110a, 110b, 110c) and/or by multiple providers (116a, 116b, 116c) to an aggregation server (112). In other words, multiple log objects may exist for a desired measured value. Using wellbore pressure as an example, this measurement may be provided by multiple providers (i.e., four different providers may provide this measurement). Thus, at a particular time or depth in a given well bore (e.g., 106), multiple log objects containing a wellbore pressure measurement may be available. Each log object containing a wellbore pressure measurement may be recorded by a different provider in the provider's proprietary format. Further, each client of a given wellbore may request a wellbore pressure measurement in a different manner. For example, one client may request a measurement from a particular provider, while another client may request an average of all measurements provided.

Thus, one function of an aggregation server (112) is to provide a data value, in the form of an aggregated element, to a client. Aggregated elements are contained in aggregated objects, an example of which is shown in FIG. 2B. The aggregated object (232), in accordance with an embodiment of the invention, includes one or more aggregated elements (234a, 234m), with each aggregated element corresponding to an aggregated value (236a, 236m). Each aggregated element corresponds to a parameter that specifies a particular measurement to be provided to a client. Like a log object (202) discussed above, the aggregated element (234a) is a parameter indicating a type of measurement that corresponds to an aggregated value (e.g., 203a). An aggregated value is the value that a client may request. Unlike a log value, an aggregated value may be a single measurement, or some aggregation of similar log values obtained by an aggregation server. Similar to log objects, aggregated objects may be coded such that they contain information corresponding to a measurement and a value, allowing a single aggregated element to be used instead of an aggregated element/aggregated value pair. In general, data in an aggregated object is accessible in a common format (e.g., using the WITSML standard). However, this may vary by factors such as the well, the provider, client preferences, or the aggregation server.

Returning to FIG. 1, in one embodiment of the invention, the aggregation server (112) is configured to aggregate log objects from a given well into a single composite for the well. This allows for storage and access of multiple values that may be of interest to a client (114a, 114b). The aggregation server (112) may be located on site, or connected remotely via a means well known to one skilled in the art. For example, the aggregation server (112) may receive incoming data via a satellite connection or via the internet.

One skilled in the art will appreciate that while the exemplary providers, (116a, 116b, 116c), aggregation server (112), and clients (114a, 114b) have each been represented as individual components with discrete functionality, one or more of these components may be combined in various embodiments of the invention. For example, the aggregation server (112) may additionally include the functionality of a client and a provider in one or more embodiments of the invention. Similarly, a provider may additionally include the functionality of a client and an aggregation server in one or more embodiments of the invention. Further, a client may additionally include the functionality of an aggregation server and a provider in one or more embodiments of the invention.

One or more clients (114) request particular data values from the aggregation server (112). Further, the client (114) may request a data value from a preferred provider. In other words, even if multiple data values are available from multiple providers for a given measurement, the client (114) may request a data value from a preferred provider. Alternatively, the client (114) may request a particular order of providers or means of combining measurements from multiple providers for a data value. Similar to the aggregation server (112), the client (114) may be located on site or at a remote location.

A determination as to how log objects are to be aggregated, stored, and provided to clients is made based on an aggregation policy. FIG. 2C shows an exemplary aggregation policy (252) in accordance with an embodiment of the invention. Aggregation policy (252) contains one or more elements (254a, 254m). Each element (254a, 254m) has one or more conditions associated with that element (254a, 254m), and a method of aggregation associated with each condition. For example, element 1 (254a) has associated with it conditions 1-1 (258a) to 1-N (258n). Associated with the condition 1-1 (258a) is a method of aggregation 1-1 (256a). Associated with the condition 1-N (258n) is a method of aggregation 1-N (256n). Similarly, element M (254m) has associated with it conditions M-1 (262a) to M-P (262p). Associated with the condition M-1 (262a) is a method of aggregation M-1 (260a). Associated with the condition M-P (262p) is a method of aggregation M-P (260p).

An element (254a) in an aggregation policy (252) corresponds to a measurement that a client may choose to obtain via an aggregation server. Elements (e.g., 254a), conditions (e.g., 258a), and methods (e.g., 256a) are specified by a client to an aggregation server. An aggregation server aggregates log objects into corresponding aggregated objects and provides requested measurements to a client based on an element, a condition, and a method in an aggregation policy (252).

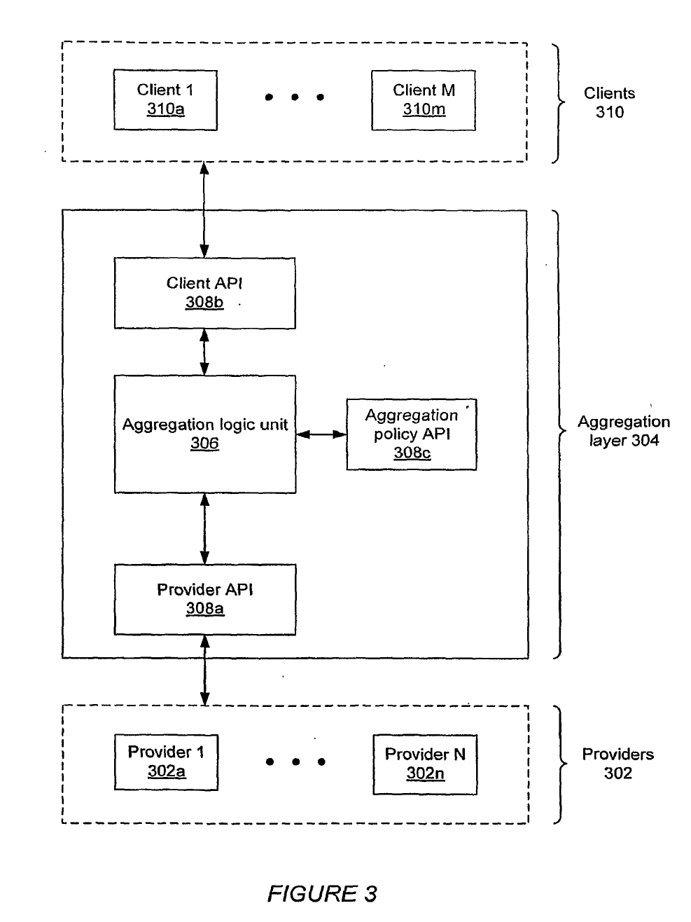

FIG. 3 shows an aggregation layer (304) of an aggregation server (112) in accordance with an embodiment of the invention. The aggregation layer (304) is configured to aggregate one or more data values (log elements) within a log object (e.g., 202) into an one or more data values (aggregated elements) in an aggregated object (e.g., 232). These data values (log elements) are obtained from measurements made by the sensors (110a, 110b, 110c) in the well bore (106). The aggregation layer (304) comprises an aggregation logic unit (306) and application programming interfaces (APIs) (308a, 308b, 308c). Those having ordinary skill in the art will appreciate the numbers and types of objects that may be used in planning, drilling, and/or producing a formation.

A provider layer (302) and a client layer (310) interface with the log object API (308a) and the aggregated object API (308b), respectively. The provider layer (302) includes one or more providers of data (e.g., provider 1 (302a)), each configured to send particular data (in the form of a unique log object) to the aggregation layer (304). A provider (e.g., Provider 1 302a, Provider N 302n) may be a sensor (e.g., 110a) that sends a log object directly to aggregation layer (304), or the provider may be an intermediary, e.g., a computer system that obtains the log object from a sensor and forwards it to the aggregation layer (304). In one or more embodiments of the invention, the providers (302a, . . . , 302n) transfer log objects to the aggregation layer (304) using the industry standard WITSML. These log objects are obtained by the log object API (308a) when sent by a provider, or at the request of the aggregation logic unit (306). The log object API (308a) may store a log object locally, or the log object may be stored at a location external to the aggregation layer (304) (i.e., an external datastore). In one embodiment of the invention, the log object is stored temporarily in a cache associated with the log object API (208a).

Thus, the aggregation layer (304) is configured to obtain one or more oilfield data values in the form of log elements from the provider layer (302) via the log object API (308a). The aggregation logic unit (306) is configured to aggregate these log elements in the form of one or more aggregated elements into an aggregated object (not shown), and to send one or more aggregated data values to the client layer (310) via the aggregated object API (308b). The aggregation logic unit (306) may perform any conversion necessary, for example, when a log object is provided in a proprietary format. Like the log objects, the aggregated objects may be stored locally or remotely.

The aggregation policy API (308c) obtains one or more aggregation policies for the aggregation of log objects into aggregated objects. As discussed above, the aggregation policy is used to aggregate a log element, as an aggregated element, into an aggregated object in a manner that is consistent with a given client's request. Like the log objects and aggregated objects, the aggregation policy may be stored locally or remotely. The aggregation policy stores priority information for clients associated with a given well drilling project. When multiple values are available for a particular measurement, a client may specify a rule for obtaining an aggregated element for that measurement. One skilled in the art will appreciate that an aggregation policy may have aggregation rules for a plurality of clients.

The client layer (310) includes one or more clients (e.g., Client 1 (310a), Client M (310m)), each of which may request one or more data values from the aggregation layer (304). In one or more embodiments of the invention, the clients (310a, 310m) request data using the industry standard WITSML. This data, which is in an aggregated object, is sent by the aggregated object API (308b) when requested by a client, or at another predetermined time (e.g., after aggregation by the aggregation logic unit (306)). The aggregated object API (308b) may have stored an aggregated object containing the requested data locally, or the aggregated object may be stored at a location external to the aggregation layer (304). In one embodiment of the invention, aggregation policies, log elements, and aggregated elements are obtained from a datastore (not shown) by the aggregation logic unit (304) as needed.

One skilled in the art will appreciate that while the provider API (308a), the client API (308b), and the aggregation policy API (308c) are shown as being distinct from the aggregation logic unit, in one or more embodiments of the invention, each of these APIs may be part of the aggregation logic unit (306). Thus, the aggregation logic unit (306) may include the functionality of each of the separate APIs. In other words, the APIs may be inherent to the structure of the aggregation logic unit (306) in one or more embodiments of the invention. Thus, the aggregation logic unit (306) may perform the task of obtaining a log object from a provider. Similarly, an aggregation policy API and a client API may also be present in the aggregation logic unit (306), and structures for these APIs are not necessarily external to the aggregation logic unit (306). Thus, the aggregation logic unit (306) may obtain aggregation policies and provide requested values to a client via an internal aggregation policy API and an internal client API, respectively. One skilled in the art will appreciate that an aggregation logic unit may be implemented by means of hardware or software.

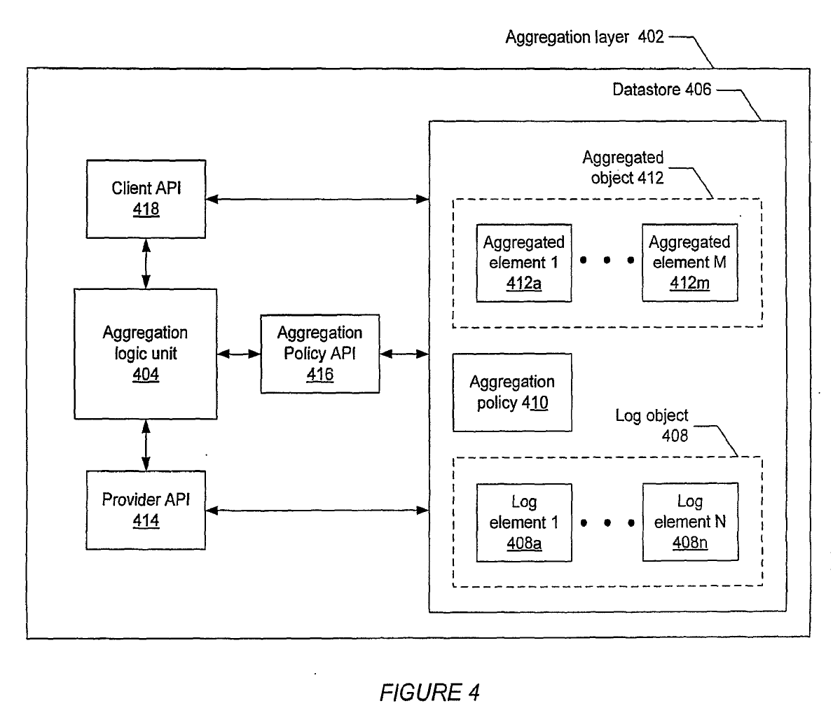

FIG. 4 shows an aggregation layer (402) in accordance with an embodiment of the invention. Specifically, FIG. 4 shows an aggregation layer (402) including an aggregation logic unit (404), a provider API (414), an aggregation policy API (416), a client API (418), and a datastore (406). Within the datastore (406) is a log object (408), an aggregation policy (410), and an aggregated object (412). Thus, all information relevant to the aggregation of a log element into an aggregated object is stored in the datastore (406). The log object (408) includes one or more log elements (e.g., log element 1 (408a) to log element N (408n)), while the aggregated object (412) includes one or more aggregated elements (e.g., aggregated element 1 (312a) to aggregated element M (312m)).

The provider API (414) is configured to obtain log elements from providers (not shown) and to interface with the datastore (406) in order to store and retrieve log objects and log elements (e.g., log object (408), log element 1 (408a)) from the datastore (406). The client API (418) is configured to provide aggregated objects to clients (not shown) and to interface with the datastore (406) in order to store and retrieve aggregated objects and aggregated elements (e.g., aggregated object (412), aggregated element 1 (412a)) from the datastore (406). The aggregation policy API (416) is configured to obtain and store one or more aggregation policies from one or more clients (not shown). The provider API (414), the aggregation policy API (416), and the client API (418) each communicate with the aggregation logic unit (404) as necessary to perform their respective functions. One skilled in the art will appreciate that one or more of the above APIs may be functionally integrated with the aggregation logic unit (404).

In FIG. 4, while the aggregation layer (402) has been shown with a single log object (408) and a single aggregated object (412), one skilled in the art will appreciate that any number of log objects and aggregation objects may be present. For example, multiple sensors may produce multiple log objects. Additionally, if different clients require different aggregation policies, multiple aggregated objects or aggregated elements may be stored (i.e., one aggregated object or aggregated element for each client). In one embodiment of the invention, the aggregation logic unit (404) uses a standard naming convention for aggregated elements, and is configured to receive queries in a standard WITSML-formatted request for data.

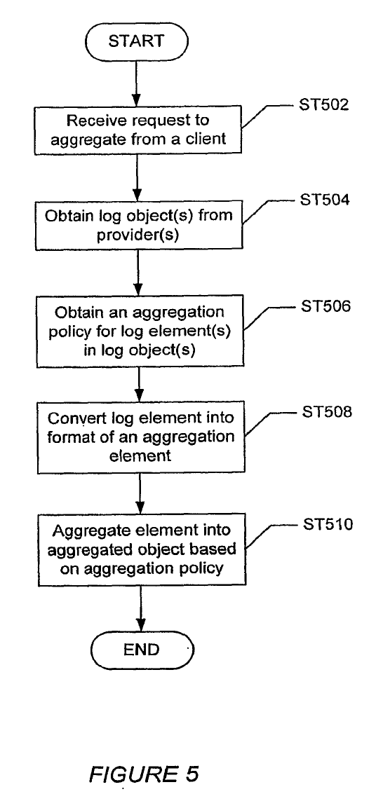

FIG. 5 shows a flowchart depicting a method of aggregating a log object in accordance with an embodiment of the invention. Beginning with ST502, a log object is obtained from a provider. This log object may be obtained for a number of reasons. For example, a provider may provide measurements at particular time intervals or depths in a well, or a client may request data values at particular time intervals or depths in a well. Further, while a single log object and a single provider are discussed with respect to FIG. 5, it will become apparent to one skilled in the art that in a similar manner, any number of log objects can be obtained from any number of providers.

After a log object is obtained, an aggregation policy is obtained for any log elements in the log object (ST504). In one or more embodiments of the invention, an aggregation logic unit (e.g., 404) may obtain an aggregation policy (e.g., 410) via an aggregation policy API (e.g., 416). An aggregation policy may be established and stored prior to the aggregation of a log element, or an aggregation policy may be established upon reception of a log element in an aggregation layer.

Numerous aggregation policies may be specified by a client to an aggregation server. In one embodiment of the invention, a client may request a particular provider for a measurement, and a log element may be stored as an aggregated element in a corresponding aggregated object for that client. Similarly, secondary (tertiary, etc.) providers of data values may be specified by the client. In other words, a client may specify a priority of providers for particular log elements. In the absence of a policy for a particular client for a requested value, an aggregation logic unit may default to forming an average of all log elements obtained for the requested value, or aggregate the first available log element for an aggregated element. Those of ordinary skill in the art will appreciate that a median, maximum, minimum, or any other suitable value may be used. In other embodiments of the invention, a client may request a preferred provider for a given range of values for a particular measurement, while another provider may be specified as a preferred provider for another range of values.

If necessary (e.g., when a log element is in a non-native format), the log element is converted into an appropriate format to be aggregated into an aggregated object (ST506). Then, the log element is aggregated into an aggregated object based on the previously obtained aggregation policy (ST508).

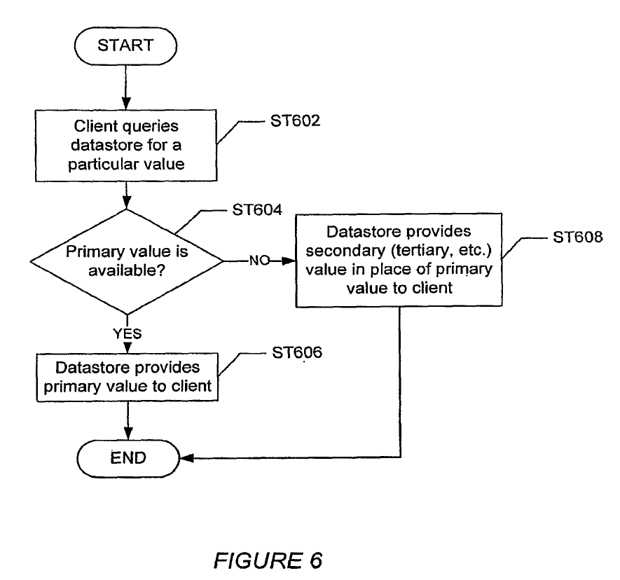

Once an aggregated object contains aggregated elements, a client may wish to obtain one or more data values from the aggregated object. For example, as shown in FIG. 6, a client (e.g., client 1 (210a)) may request a particular data value from the datastore (ST602). Such a request may be made, for example, using an XML query consistent with the WITSML standard. A decision is made as to whether a primary value (e.g., a desired value from a particular provider) is available (ST604).

If a primary value is available in the datastore, this value is provided to the client (ST606). If the primary value is not available, a secondary (tertiary, etc.) value is provided to the client in place of the primary value (ST608), and the source provider is identified for the substitution.

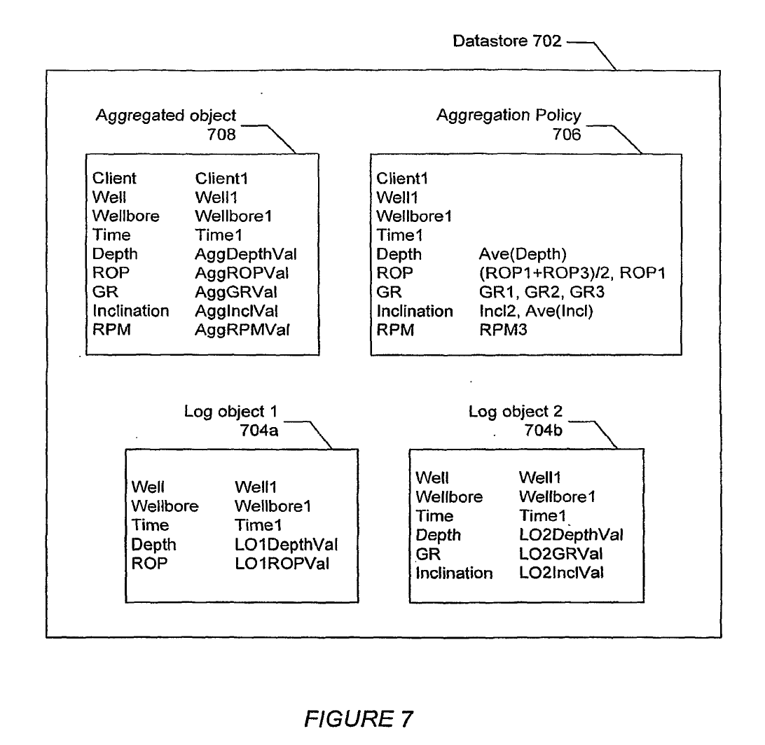

FIG. 7 shows an example of a datastore (702) in accordance with an embodiment of the invention. The datastore (702) includes a plurality of log objects (704a, 704b), an aggregation policy (706), and an aggregated object (708). Each log object contains log elements and corresponding log values. The log objects (704a, 704b) and the aggregated object (708) are each identified by a well and/or a wellbore ID, as well as a time. Thus, each log object and aggregated object is distinguishable from other log objects or aggregated objects. As drilling progresses in a given well bore, log objects (e.g., 704a, 704b) are added to the aggregated object (708) based on information obtained from the aggregation policy (706). The aggregated object (708) contains aggregated objects (e.g., client, provider, time, ROP), as well as corresponding aggregated values.

For example, as shown in FIG. 7, the depth of the aggregated object (708) for client 1 (AggDepthVal) is determined by taking an average of all received depth values for the particular well, wellbore, and time (i.e., LO1DepthVal and LO2DepthVal). On the other hand, the rate of penetration (ROP) for Client 1 (AggROPVal) is obtained by taking the average of the ROP values obtained from log object 1 (704a) and log object 3 (not shown). However, as log object 3 is not available, the ROP is determined only from the ROP log value in log object 1 (704a) (i.e., LO1ROPVal). These values are determined based on obtaining the appropriate policy in the aggregation policy (706).

One skilled in the art will appreciate that one or more of the aforementioned elements of the datastore (702) may be located in a separate location (e.g., on a separate datastore (not shown)). The use of a datastore provides a storage facility for data for all providers and clients associated with a given drilling project. In one embodiment of the invention, the datastore (702) may be accessible only by authenticated users (providers or clients) associated with the given well or wellbore.

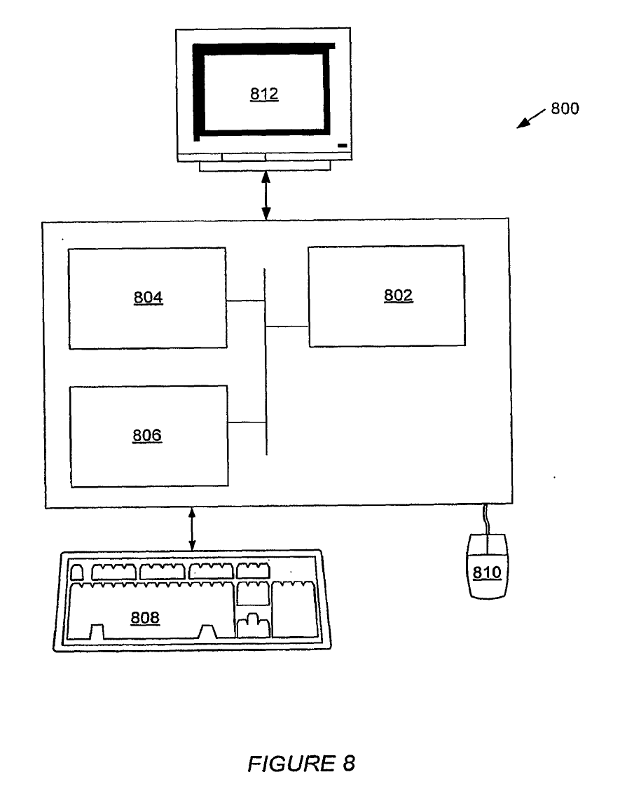

The present invention may be implemented on virtually any type of computer system, regardless of the platform being used. For example, as shown in FIG. 8, a networked computer system (800) includes a processor (802), associated memory (804), a storage device (806), and numerous other elements and functionalities typical of a computer (not shown). The networked computer (800) may also include input means, such as a keyboard (808) and a mouse (810), and output means, such as a monitor (812). The networked computer system (800) is connected to a local area network (LAN) or a wide area network (e.g., the Internet) (not shown) via a network interface connection (not shown). Those skilled in the art will appreciate that these input and output means may take other forms.

Further, one skilled in the art will appreciate that one or more elements of the aforementioned computer system (800) may be located at a remote location and connected to the other elements over a network. Further, the present invention may be implemented on a distributed system having a plurality of nodes, where each portion of the invention may be located on a different node within the distributed system. Further, software instructions to perform embodiments of the invention may be stored on a computer readable medium such as a compact disc (CD), a diskette, a tape, a file, or any other computer readable storage device.

It will be appreciated that data to be aggregated may come from a variety of sources. The data may come from prior field information, geologic survey information, prior wells, etc. Those having ordinary skill in the art will appreciate the number of sources that may be involved with the planning, drilling, and production of an oil or gas well.

In one specific example of how data may be obtained to put into a database to be aggregated in accordance with embodiments of the present invention, while drilling, it is desirable to gather as much data about the drilling process and about the formations through which the wellbore penetrates. The following description provides examples of the types of sensors that are used and the data that is collected. It is noted that in practice, it is impractical to use all of the sensors described below due to space and time constraints. In addition, the following description is not exhaustive. Other types of sensors are known in the art that may be used in connection a drilling process, and the invention is not limited to the examples provided herein.

The first type of data that may be collected may be classified as near instantaneous measurements, often called “rig sensed data” because it is sensed on the rig. These include the WOB and the TOB, as measured at the surface. Other rig sensed data include the RPM, the casing pressure, the depth of the drill bit, and the drill bit type. In addition, measurements of the drilling fluid (“mud”) are also taken at the surface. For example, the initial mud condition, the mud flow rate, and the pumping pressure, among others. All of these data may be collected on the rig at the surface, and they represent the drilling conditions at the time the data are available.

Other measurements are taken while drilling by instruments and sensors in the bottom hole assembly (BHA). These measurements and the resulting data are typically provided by an oilfield services vendor that specializes in making downhole measurements while drilling. The invention, however, is not limited by the party that makes the measurements or provides the data.

As described above in reference to FIG. 1, a drill string typically includes a BHA that includes a drill bit and a number of downhole tools. Downhole tools may include various sensors for measuring the properties related to the formation and its contents, as well as properties related to the wellbore conditions and the drill bit. In general, “logging-while-drilling” (“LWD”) refers to measurements related to the formation and its contents. “Measurement-while-drilling” (“MWD”), on the other hand, refers to measurements related to the wellbore position and the drill bit condition. The distinction is not germane to the present invention, and any reference to one should not be interpreted to exclude the other.

LWD sensors located in BHA may include, for example, one or more of a gamma ray tool, a resistivity tool, an nuclear magnetic resonance tool, a sonic tool, a formation sampling tool, a neutron tool, and electrical tools. Such tools are used to measure properties of the formation and its contents, such as, the formation porosity, formation permeability, density, lithology, dielectric constant, formation layer interfaces, as well as the type, pressure, and viscosity of the fluid in the formation.

One or more MWD sensors may also be located in BHA. MWD sensors may measure the loads acting on the drill string, such a WOB, TOB, and bending moments. It is also desirable to measure the axial, lateral, and torsional vibrations in the drill string. Other MWD sensors may measure the azimuth and inclination of the drill bit, the temperature and pressure of the fluids in the wellbore, as well as properties of the drill bit such as bearing temperature and grease pressure.

The data collected by LWD/MWD tools is often relayed to the surface before being used. In some cases, the data is simply stored in a memory of the tool and retrieved when the tool is brought back to the surface. In other cases, LWD/MWD data may be transmitted to the surface using known telemetry methods.

Telemetry between the BHA and the surface, such as mud-pulse telemetry, may be slow and only enable the transmission of selected information. Because of the slow telemetry rate, all the data from LWD/MWD tools may not be available at the surface for several minutes after the data is collected. In addition, the sensors in a BHA may be located behind the drill bit, by as much as fifty feet. Thus, the data received at the surface may be slightly delayed due to the telemetry rate, and the position of the sensors in the BHA.

Other measurements are made based on lagged events. For example, drill cuttings in the return mud may be analyzed to gain more information about the formation that is drilled. During the drilling process, the drill cuttings are transported to the surface in the mud flow through an annulus formed between drill string and wellbore. In a deep well, for example, drill bit may drill an additional 50 to 100 feet while drill cuttings travel to the surface. Thus, the drill bit continues to advance an additional distance while the drilled cuttings from the depth position of interest are transported to the surface in the mud circulation system. Therefore, the data may be lagged by at least the time to circulate the cuttings to surface.

Analysis of the drill cuttings and the returning drilling mud may provide additional information about the formation and its contents. For example, the formation lithology, compressive strength, shear strength, abrasiveness, and conductivity may be measured. Measurements of the returning drilling mud temperature, density, and gas content may also yield data related to the formation and its contents.

Referring now to FIG. 9, a schematic of drilling communications system (500) in accordance with embodiments of the present invention is shown. A drilling system, including the drilling rig and other equipment, at a drilling site (502) is connected to a remote data store (501). As data is collected at drilling site (502), the data is transmitted to data store (501).

As discussed above, the remote data store may use a Wellsite Information Transfer Standard (“WlTSML”) data transfer standard. Other transfer standards may also be used without departing from the scope of the invention.

Additional party connections to data store (501) may include an oilfield services vendor (503), a drilling simulation (504), and third party and remote users (505). In some embodiments, each of the different parties (502, 503, 504, 505) that have access to data store (501) may be in different locations. In practice, oilfield service vendors (503) are typically located at drilling site (502), but are shown separately because vendors (503) represent a separate party having access to data store (501). In addition, embodiments of the present invention do not preclude vendor (503) from transmitting the LWD/MWD measurement data to a separate site for analysis before the data is uploaded to data store (501).

In addition to having data store (501) located on a secure server, in some embodiments, each of the parties connected to data store (501) has access to view and update only specific portions of the data therein. For example, a vendor (503) may be restricted such that they cannot upload data related to drill cutting analysis, a measurement which is typically not performed by the vendor.

As measurement data becomes available, it may be uploaded to data store (501). The data may be correlated to the particular position in the wellbore to which the data relates, a particular time stamp when the measurement was taken, or both. The normal rig sensed data (e.g., WOB, TOB, RPM, etc.) will generally relate to the drill bit position in the wellbore that is presently being drilled. As this data is uploaded to data store (501), it will typically be correlated to the position of the drill bit when the data was recorded or measured.

Vendor data (e.g., data from LWD/MWD instruments), as discussed above, may be slightly delayed. Because of the position of the sensors relative to the drill bit and the delay in the telemetry process, vendor data may not relate to the current position of the drill bit when the data becomes available. Still, the delayed data will typically be correlated to a specific position in the wellbore when it was measured and then is uploaded to data store (501). It is noted that the particular wellbore position to which vendor data is correlated may be several feet behind the current drill bit position when the data becomes available.

In some embodiments, the vendor data may be used to verify or update rig sensed data that has been previously recorded. For example, one type of MWD sensor that is often included in a BHA is a load cell or a load sensor. Such sensors measure the loads, such as WOB and TOB, that act upon the drill string near the bottom of the wellbore. Because data from near the drill bit will more closely represent the actual drilling conditions, the vendor data may be used to update or verify similar measurements made on the rig. One possible cause for a discrepancy in such data is that the drill string may encounter friction against the wellbore wall. When this occurs, WOB and TOB measured at the surface will tend to be higher that the actual WOB and TOB experienced at the drill bit.

The process of drilling a well typically includes several “trips” of the drill string. A trip is when the entire drill string is removed from the well to, for example, replace the drill bit or other equipment in the BHA. When the drill string is tripped, it is common practice to lower one or more wireline tools into the well to investigate the formations that have already been drilled. Typically wireline tool measurements are performed by an oilfield services vendor.

Wireline tools enable the use of sensors and instruments that may not have been included in the BHA. In addition, the wire that is used to lower the tool into the well may be used for data communications at much higher rates than are possible with telemetry methods used while drilling. Data obtained by wireline tools may be uploaded to the data store so that the data may be used in future simulation methods performed for the current well, once drilling continues.

As mentioned above, it is often the case that some of the collected LWD/MWD data may not be transmitted to the surface due to constraints in the telemetry system. Therefore, it is common practice to store the data in memory of the downhole tool so that it may be retrieved when the BHA is removed during a trip out. When the BHA is removed from the well during a trip of the drill string, a surface computer may be connected to the BHA sensors and instruments to obtain all of the data that was gathered. As with wireline data, this newly retrieved LWD/MWD data may be uploaded to the data store for use in the continuous or future optimization methods.

In a manner similar to vendor data, data from lagged events may also be correlated to the position in the wellbore to which the data relates. As the data is lagged, the correlated position may be a position many feet above the current position of the drill bit by the time the data becomes available and is uploaded to data store 501. For example, data gained through the analysis of drill cuttings may be correlated to the position in the wellbore where the cuttings were produced but by the time such data becomes available, the drill bit may have drilled many additional feet.

As with certain types of vendor data, some lagged data may be used to update or verify previously obtained data. For example, analysis of drill cuttings may yield data related to the porosity or lithology of the formation. Such data may then be used to update or verify vendor data that is related to the same properties. In addition, some types of downhole measurements are dependent of two or more properties. For example, narrowing the possible values for porosity, may yield better results for other formation properties. The newly available data, as well as data updated from lagged events, may then be used in future optimization methods.

Referring now to FIG. 10 a schematic of one example of communications at a drilling site is shown. A rig network (511) is generally used to connect the components on drilling rig 10 or at a rig site so that communication is possible. For example, most of the rig sensed data and lagged data are measured at the rig floor, represented generally at (512). The data collected at rig floor (512) may be transmitted, through rig network (511), to locations where the data may be useful. For example, the data may be recorded on chart recorders and printers or plotters, represented generally at (517). The data may then be transmitted to a rig floor display, shown generally at (516), or to a display for the tool pusher (Rig Manager) of company man (Operator Representative), shown generally at (515).

In addition, a vendor, shown generally at (503) may collect data, such as LWD/MWD and wireline data, from downhole tools, shown generally at (514). Such data may then be communicated, through the rig network (511), to locations where the data may be needed.

In the example shown in FIG. 10, rig network (511) is connected to a remote data store (501). As discussed above, remote data store (501) may be located apart from the drilling site. For example, rig network (511) may be connected to data store (501) through a secure internet connection. In addition to rig network (511), other users may also be connected to data store (501). For example, as shown in FIG. 10, tool pusher or company man (515) may be connected to data store (501) so that data may be directly queried from data store (501). Also, a vendor (503) may be connected to data store (501) so that vendor data may be uploaded to data store (501) as soon as it becomes available.

In addition, operator personnel (519) (e.g., other persons involved in drilling, exploration, reservoir management, and/or HSE) may access remote data store (501). In addition, other service providers (520) (e.g., other persons involved in engineering software, monitoring/log viewers, reporting, 3-D visualization, process optimization, materials/re-supply). It should be understood that the schematic in FIG. 10 is exemplary only. Other configurations may be used without departing from the scope of the invention.

In one or more embodiments of the invention, using a standard request for data allows any user to create a simple, efficient query directed to a single datastore. Thus, the burden of finding a provider for a desired data value is greatly reduced. Further, the use of a standard query allows for a quick, efficient return of information from a datastore in response to the query.

Further, in one or more embodiments of the invention, a client may find a measurement for a desired data value, even if the measurement was not taken by a desired provider. As multiple suppliers of a given data value may be specified, even when a primary provider of a desired data value is unable to furnish a measurement for the desired data value, another provider may be able to provide that value. Thus, a failure of a sensor or a particular transmission of a data value for one provider may not limit a user from finding a usable measurement for a desired data value, and no interruption of service is seen by a client.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for aggregating data, comprising:
obtaining a log object comprising a log element, wherein the log element comprises oilfield data obtained from a provider;
obtaining an aggregation policy for the log element;
aggregating the log element into an aggregated object based on the aggregation policy.

2. The method of claim 1, further comprising:
converting the log element to a common format.

3. The method of claim 1, further comprising:
providing a requested aggregated element to a client.

4. The method of claim 3, wherein:
the requested aggregated element is provided based on an XML query from the client.

5. The method of claim 1, wherein:
the aggregated element comprises data from the provider in a common format.

6. The method of claim 5, wherein:
the aggregated element is a Wellsite Information Transfer Standard Markup Language (WITSML) formatted data object.

7. The method of claim 1, wherein:
the log element is in a common format.

8. The method of claim 1, wherein:
the log element is in a format that is native to the data provider.

9. An aggregating datastore server, comprising:
a log object application programming interface (API) configured to obtain a log object comprising a log element, wherein the log element comprises oilfield data obtained from a provider;
an aggregation policy API configured to obtain an aggregation policy for the log element; and
an aggregation logic unit configured to aggregate the log element into an aggregated object based on the aggregation policy.

10. The aggregating datastore server of claim 9, further comprising:
an aggregated object API configured to provide an aggregated element that corresponds to the log element to a client.

11. The aggregating datastore server of claim 9, wherein:
the aggregation logic unit converts the log element into the aggregated element.

12. The aggregating datastore server of claim 9, wherein:
the aggregating datastore server is a Wellsite Information Transfer Standard Markup Language (WITSML) datastore server.

13. The aggregating datastore server of claim 9, wherein:
the log element is in a format that is native to the provider.

14. The aggregating datastore server of claim 9, wherein:
the aggregated element comprises data from the provider in a common format.

15. The aggregating datastore server of claim 14, wherein:
the aggregated element is a Wellsite Information Transfer Standard Markup Language (WITSML) formatted data object.

16. The aggregating datastore server of claim 9, wherein:
the aggregation policy comprises at least one condition and a corresponding method of aggregation for the log element.

17. The aggregating datastore server of claim 9, wherein:
the aggregation policy stores a priority of the provider for the aggregated element for a particular client.

18. The aggregating datastore server of claim 9, wherein:
the aggregating datastore server is a web-based server.

19. The aggregating datastore server of claim 9, wherein:
the log element comprises a log element and a log value.

20. The aggregating datastore server of claim 9, wherein:
the aggregated element comprises an aggregated element and an aggregated value.

21. A computer readable medium comprising software instructions for aggregating data in an aggregating datastore server, the software instructions executable on the aggregating datastore server to:
obtain a log object comprising a log element, wherein the log element comprises oilfield data obtained from a data provider;
obtain an aggregation policy; and
aggregate the log element into an aggregated object based on the aggregation policy.
